(19) United States
(12) Patent Application Publication
(10) Pub. No.: US 2003/0138190 A1
(43) Pub. Date: Jul. 24, 2003

(54) Optical switch and optical waveguide device

(75) Inventor: Seiichiro Tabata, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/196,213

(22) Filed: Jul. 17, 2002

(30) Foreign Application Priority Data
Jan. 18, 2002 (JP) 2002-009539(P)

(51) Int. Cl. G02B 6/35

(52) U.S. Cl. 385/16

(57) ABSTRACT

An optical switch allowing easy alignment of a cut portion with a pressurizing member pressurizing a waveguide accommodating sheet, an optical waveguide device, are obtained. The optical switch includes a cut portion formed by cutting in the waveguide accommodating sheet from one surface thereof, a contact member at least on that side of the waveguide accommodating sheet which is opposite to the cutting side, having a fixed portion fixed in the vicinity of the cut portion and a pressurizing portion positioned to be continuous with the fixed portion and two-dimensionally overlap the cut portion, and a piezoelectric actuator positioned such that the pressurizing portion is sandwiched between the actuator and the waveguide accommodating sheet, thereby moving to press the pressurizing portion against the waveguide accommodating sheet and to disengage the pressurizing portion from the waveguide accommodating sheet.

### BACKGROUND OF THE INVENTION

1. Field of the Invention

The present invention relates to an optical switch for use in switching connection destinations in optical communication facilities in optical communication and an optical waveguide device.

2. Description of the Background Art

Referring to FIG. 10, a conventional optical switch is provided for an optical waveguide 105 in film-like polymer 102 as a waveguide accommodating sheet pressed by a press plate 103. A polyimide film or the like may be used as film-like polymer forming a waveguide accommodating sheet. As shown in FIG. 11, in an optical connection on-state (referred to as on-state hereinafter) in which a drive mechanism (push rod) 106 does not press a cut portion at the intersection of the waveguides running vertically and horizontally, waveguide accommodating sheet 102 has cut end surfaces 102a tightly connected at the cut portion. Therefore, a core, which is waveguide 105, is also tightly connected at the cut portion. As a result, light arriving at the tightly connected cut portion passes through the cut portion uninterruptedly.

On the other hand, in an optical connection off-state (referred to as off-state hereinafter) in which push rod 106 presses the cut portion, as shown in FIG. 12, push rod 106 forces end surfaces 102a apart from each other to bring them in contact with air. Therefore, light propagating in a waveguide with a high index of reflection is totally reflected by an air layer of gap 109 to change the direction approximately 90° for propagation.

With the mechanism described above, in FIG. 10, in the optical connection on-state at the intersection of waveguides, optical inputs L1, L2 pass uninterruptedly through the part where cut end surfaces 102a are tightly connected at intersection 111 of waveguides. On the other hand, in the optical connection off-state at the intersection of waveguides, both light inputs L1 and L2 are totally reflected at the optical switch part to change the direction approximately 90° for propagation in a prescribed direction. As described above, the conventional optical switch is characterized in that push/pull of one push rod 106 switches the direction of light.

The optical switch described above causes a problem when the off-state changes to the on-state. Specifically, when the off-state in which light is totally reflected by pushing of the push rod changes to the on-state in which light is transmitted, only a restoring force is exerted which results from the elastic force of the film-like polymer when the push road retracts. Therefore, cut end faces 102a of film-like polymer 102 are not connected tightly enough, and core 105 forming the waveguide is thus not connected tightly enough.

Unfortunately, in the configuration of the optical switch shown in FIGS. 11 and 12, it is difficult to arrange the push rods accurately in alignment with the same number of myriad cut portions. In optical switches where thirty-two vertical waveguides cross over thirty-two horizontal waveguides to form a matrix with thirty-two rows and thirty-two columns, all of the 1024 piezoelectric actuators must be in alignment with the cut portions within a given accuracy. A large number of steps are required to effect alignment of such an enormous amount of piezoelectric actuators individually for each piezoelectric actuator, and in addition a high degree of skill is required to attain the intended accuracy of arrangement.

### SUMMARY OF THE INVENTION

An object of the present invention is to provide an optical switch allowing easy alignment of a film-like polymer pressurizing member with a cut portion and easy tight connection of cut end faces 102a, an optical waveguide device.

An optical switch in accordance with the present invention is provided in an optical waveguide device including a waveguide allowing propagation of light and a waveguide accommodating sheet accommodating the waveguide. The optical switch includes: a cut portion formed by cutting in the waveguide accommodating sheet from one surface thereof across the waveguide; a contact member positioned at least on that side of the waveguide accommodating sheet which is opposite to a side of the cutting in and having a fixed portion and a pressurizing portion, the fixed portion being fixed in the vicinity of the cut portion, the pressurizing portion being positioned to be continuous with the fixed portion and two-dimensionally overlap the cut portion; and a drive member positioned such that the pressurizing portion is sandwiched between the drive member and the waveguide accommodating sheet whereby the drive member advances toward the pressurizing portion to press the pressurizing portion against the waveguide accommodating sheet and retracts away from the pressurizing portion to disengage the pressurizing portion from the waveguide accommodating sheet.

Because of this configuration, it becomes unnecessary to align the drive member with the cut portion of the waveguide accommodating sheet accurately. More specifically, since gap creation or connection in the cut portion is effected by abutment or disengagement of the pressurizing portion moved by the drive member, it is possible to decrease the accuracy of alignment of the drive member with the cut.

Note that the cutting-in at the cut portion may have any depth as long as it traverses the waveguide. For example, the cut may extend through the entire thickness of the waveguide accommodating sheet, that is, the sheet may be completely cut off. In case of this cut-off, “at least on that side of the waveguide accommodating sheet which is opposite to a side of the cutting in” described above should read as “at least one surface of the waveguide accommodating sheet”.

The pressurizing portion may include a sheet contact portion to come into contact with the waveguide accommodating sheet at the cut portion and a drive member contact portion to come into contact with the drive member. The sheet contact portion and the drive member contact portion may be arranged to be two-dimensionally separated.

When the drive member contact portion and the sheet contact portion are located near and far from the fixed portion, respectively, a small stroke of the drive member can provide the sheet contact portion with a large stroke. Therefore, when the drive member is formed, for example, with a piezoelectric actuator, a piezoelectric actuator having a small amount of displacement can be used, so that the piezoelectric actuator and the electric system operating thereof can be reduced in size.

The contact members positioned corresponding to the plurality of cut portions in the optical waveguide device may be formed from one metal plate that is integrally formed.

Because of this configuration, an optical waveguide device having better control of transmitting light can be obtained with a high production yield.

It becomes unnecessary to arrange the pressurizing portion and the fixed potion for each optical switch, and only the one metal plate integrally formed is simply aligned with the waveguide accommodating sheet. Therefore, it becomes easy to align the pressurizing portion with the cut portion.

In the waveguide accommodating sheet, a frame portion may be provided along a peripheral portion of the waveguide accommodating sheet, and the integrally formed metal plate may be arranged such that it is surrounded by the frame portion.

By fitting the integrally formed metal plate into the frame portion, for example, in an extreme case, it may be unnecessary to align the cut portion with the pressurizing portion in the metal plate.

The optical waveguide device described above may include a casing supporting the waveguide accommodating sheet and the drive member. The casing may have approximately the same thermal expansion coefficient as the drive member.

The waveguide accommodating sheet can be pressurized with a certain amount of displacement, independent of the environment temperature.

In an optical waveguide device in accordance with the present invention, each optical switch includes a cut portion formed by cutting in the waveguide accommodating sheet from one surface thereof across the waveguide, and a contact member positioned at least on that side of the waveguide accommodating sheet which is opposite to a side of the cutting in and having a fixed portion and a pressurizing portion. The fixed portion is fixed in the vicinity of the cut portion and the pressurizing portion is positioned to be continuous with the fixed portion and two-dimensionally overlap the cut portion. The optical switch further includes a drive member positioned such that the pressurizing portion is sandwiched between the drive member and the waveguide accommodating sheet, whereby the drive member advances toward the pressurizing portion to push the pressurizing portion against the waveguide accommodating sheet and retracts away from the pressurizing portion to disengage the pressurizing portion from the waveguide accommodating sheet.

The optical waveguide device may include an electrical drive unit electrically driving the drive member. The electrical drive unit may be formed by stacking a plurality of circuit boards, and adjacent drive members among the drive members may be connected to different circuit boards.

The electrical drive unit driving the drive member can be reduced in size without causing a short circuit, and in addition the optical waveguide device can be reduced in size.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view of an optical switch in an optical connection on state in accordance with a first embodiment of the present invention.

FIG. 2 is a cross sectional view of the optical switch in an optical connection off state in accordance with the first embodiment of the present invention.

FIG. 3 shows fixed portions in a grid pattern and leaf springs as pressurizing portions, formed by integrally forming a metal plate, in an optical waveguide device including a plurality of optical switches of the first embodiment of the present invention.

FIG. 4 is a cross section of FIG. 3 taken along IV-IV.

FIG. 5 is a cross sectional view of the optical switch in the optical connection off state in accordance with a second embodiment of the present invention.

FIG. 6 is a cross sectional view showing the optical waveguide device in accordance with a third embodiment of the present invention.

FIG. 7 is a cross sectional view showing the optical waveguide device in accordance with a fourth embodiment of the present invention.

FIG. 8 is a cross sectional view showing an example of an optical switch in the optical connection on state.

FIG. 9 is a cross sectional view showing the optical switch in the optical connection off state.

FIG. 10 is a perspective view of the optical waveguide device having a conventional optical switch arranged.

FIG. 11 is a cross sectional view showing the conventional optical switch in the optical connection on state.

FIG. 12 is a cross sectional view showing the conventional optical switch in the optical connection off state.

### DESCRIPTION OF THE PREFERRED EMBODIMENTS

Embodiments of the present invention will now be described with reference to the figures.

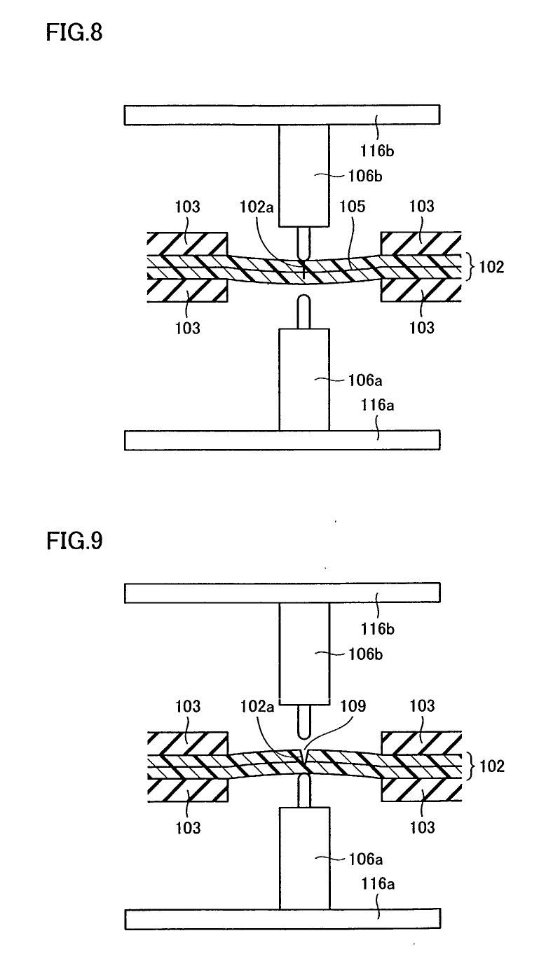

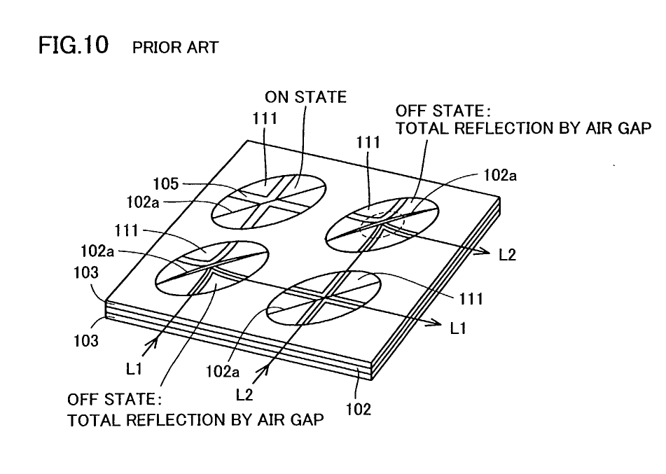

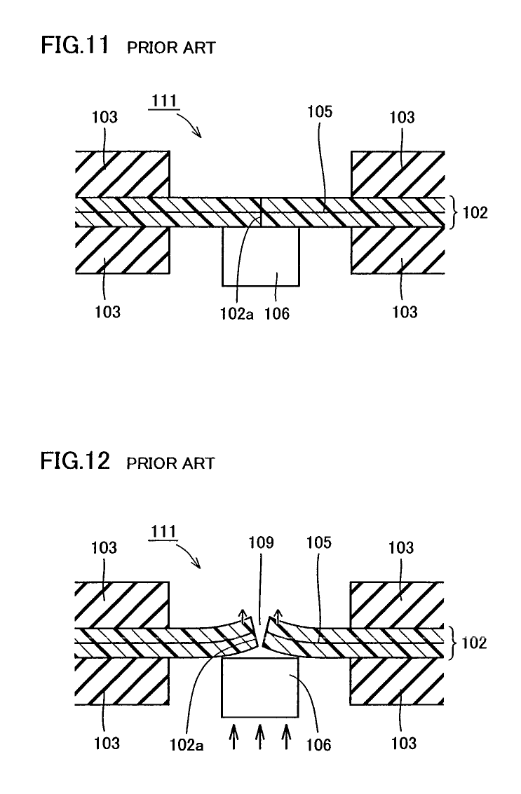

An invention was made by the inventor common to the present application, in which a highly reliable optical switch is provided allowing for stable and high accurate optical connection on/off operations at the waveguide intersection. An example of this optical switch is shown in FIGS. 8 and 9. In the optical switch shown in FIGS. 8 and 9, push rods 106a and 106b including piezoelectric actuators are arranged at both the upper and lower sides of cut portion 102a of the film-like polymer. These push rods 106a and 106b are supported by push rod-supporting plate 116a and 116b, respectively.

As shown in FIG. 8, in order to create the on-state, voltage is applied to the piezoelectric actuator arranged on the opening side of the cut portion, that is, on the upper side so that push rod 106b pressurizes the cut portion. This pressurization deforms film-like polymer 102 in a concave manner, causing the cut end faces to connect with each other, thereby realizing the on-state.

On the other hand, in order to create the off-state, voltage is applied to the piezoelectric actuator arranged on the side opposite to the opening side of the cut portion so that the push rod pressurizes the film-like polymer. This pressurization disconnects the cut surfaces from each other to create a gap 109, thereby realizing the off-state. The optical switch described above enables to achieve the reliable contact of cut end faces, while even with this optical switch it is difficult to arrange the push rods accurately in alignment with the same number of myriad cut portions. The following embodiments of the present invention have all solved this problem.

(First Embodiment)

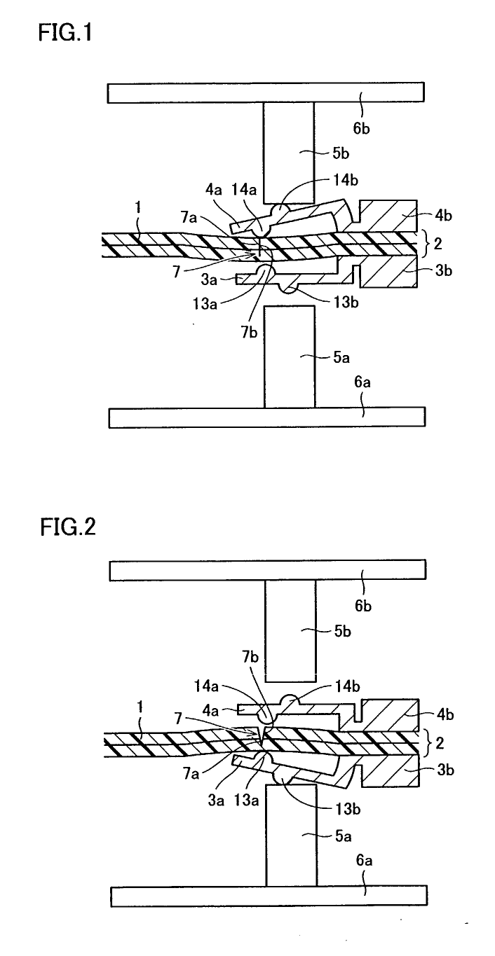

FIGS. 1 and 2 show an optical switch in a first embodiment of the present invention in cross section. Fixed portions 4b and 3b are fixed by adhesive respectively on the upper and lower surfaces of a waveguide accommodating sheet. Pressurizing portion 3a, 4a is arranged such that it is continuous with the fixed portion and kept away from waveguide accommodating sheet 1. Pressurizing portion 3a, 4a is provided with sheet-side protruding portion 13a, 14a which comes into contact with waveguide accommodating sheet 1 and drive member-side protruding portion 13b, 14b which comes into contact with a drive member.

A waveguide 2 is accommodated in waveguide accommodating sheet

1. A cut portion 7 extends to such a depth as to at least traverse waveguide

2. As long as cut surfaces 7a and 7b are in contact with each other in the on-state, the cut of the waveguide accommodating sheet may include one in which the entire thickness is completely cut off. In FIGS. 1 and 2, the drive member is formed with a piezoelectric actuator 5a, 5b. At the base portion of piezoelectric actuator 5a, 5b, an actuator supporting plate 6a, 6b including a circuit board for operating the piezoelectric actuators is arranged.

The operation of the optical switch will now be described. In FIG. 1, in which the optical switch is in the on-state and light passes through the optical switch linearly, cut surfaces 7a and 7b at cut portion 7 are tightly connected. In order to realize such tight connection, a sheet-side protrusion 14a of pressurizing portion 4a that is positioned on the cut side (the upper side) pressurizes the waveguide accommodating sheet, while a sheet-side protrusion 13a of pressurizing portion 3a on the lower side is kept away from the waveguide accommodating sheet. Pressurization by pressurizing portion 4a forces the waveguide therearound including cut portion 7 to be concave on the upper side and convex on the lower side.

On the other hand, in FIG. 2 in which cut portion 7 has its gap increased and cut surfaces 7a and 7b are kept apart from each other, pressurizing portion 3a on the side opposite to the cut side (the lower side) pushes up the waveguide accommodating sheet from the lower side to open the cut portion. Actuator 5b on the upper side is recessed and pressurizing portion 4a on the upper side is kept away from the waveguide accommodating sheet. Pressurization as described above deforms the waveguide accommodating sheet to be concave on the lower side and convex on the upper side, as shown in FIG. 2.

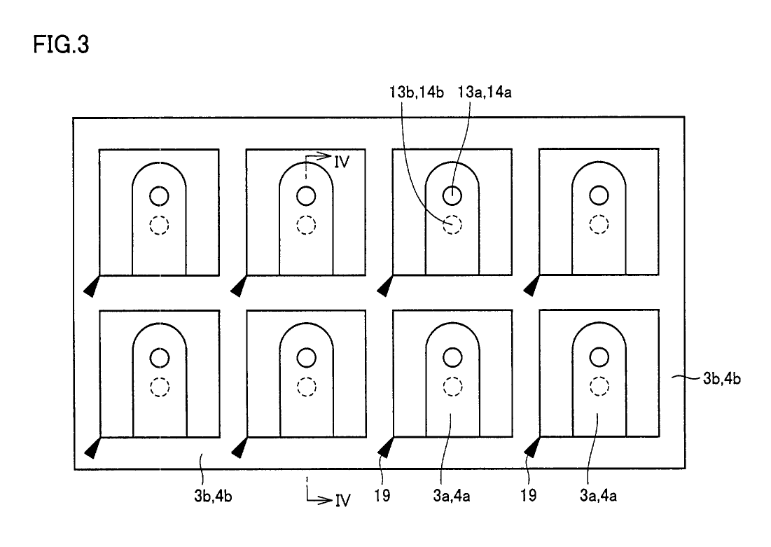

FIG. 3 shows a metal plate including the fixed portion and the pressurizing portion of the optical switch in FIG. 1, integrally formed for use in the optical waveguide device. In FIG. 3, fixed portion 3b, 4b formed in a grid pattern forms a frame of metal plate for each optical switch. This frame is arranged such that it surrounds the cut portion of the waveguide accommodating sheet. Leaf spring 3a, 4a as a pressurizing portion is provided corresponding to the cut portion such that it protrudes from the frame. The thickness of fixed portions 3b, 4b formed in a grid pattern is formed to be greater than the thickness of this leaf spring. The pressurizing portion except for the base portion thereof is kept apart from the frame since it needs to swing according to contact and non-contact with the drive member. This leaf spring is pushed by the actuator as a drive member so that it elastically deforms to come into contact with the waveguide accommodating sheet and restores to the original shape by elastic force when the drive member is away.

An alignment marker 19 is provided on the corner where the vertical bar and the horizontal bar of the frame cross each other.

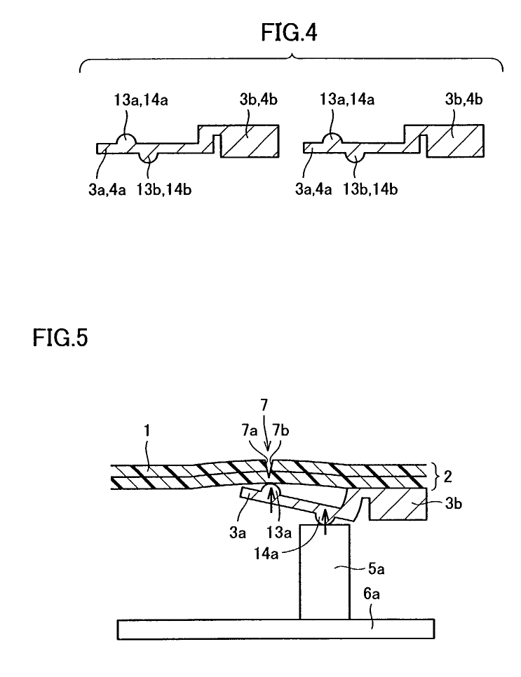

FIG. 4 is a cross section of FIG. 3 taken along IV-IV. As shown in FIG. 4, the leaf spring as a pressurizing portion is provided with a drive member-side protrusion 13b, 14b on the frond surface side near the frame and with a sheet-side protrusion 13a, 14a on the end side far from the frame.

Leaf springs 3a, 4a as pressurizing portions and fixed portions 3b, 4b in a grid pattern are formed in the metal plate that is integrally formed. Alternatively, the pressurizing portion and the fixed portion in a grid pattern may be separately formed and then connected. When the thickness of the fixed portion is greater than that of the leaf spring, in many cases, it may be simpler to fabricate separately and thereafter connect them by affixing and the like.

The aforementioned metal plate is affixed onto either side of a polyimide film as a waveguide accommodating sheet. In this affixation, where marker 19 for position adjustment provided on the metal plate is used as a reference for alignment with the cut portion of the polyimide film.

In the optical switch of the present embodiment, the piezoelectric actuator acts with the cut portion with the leaf spring interposed. Therefore, even if the piezoelectric actuator is arranged offset from the cut portion to a degree, the cut portion can be opened or tightly connected by means of the leaf spring.

Desirably, metal having a thermal expansion coefficient equivalent to that of polyimide film, about 50 ppm is used for a metal plate forming leaf spring 3a, 4a. For example, stainless steel has a thermal expansion coefficient of about 20 ppm and therefore stainless steel plate is desirably used as the metal plate. In such a manner, the use of the metal plate having a thermal expansion coefficient equivalent to that of the polyimide film can prevent the stress inwardly of the polyimide film.

In addition, provision of protrusion 13a, 14a, 12b, 14b on the front and back faces of the leaf spring can further ensure the action of the piezoelectric actuator onto the cut portion.

(Second Embodiment)

FIG. 5 is a cross sectional view of the optical switch in a second embodiment of the present invention. Drive member-side protruding portion 14a of the leaf spring in the optical switch is positioned to be more proximate to fixed portion 3b than in the first embodiment.

Therefore, when the reciprocating stroke for sheet-side protruding portion 13a to separate or tightly connect cut surfaces 7a and 7b is the same as in the first embodiment, the reciprocating stroke of the piezoelectric actuator can be made smaller. Here, the load needed for the piezoelectric actuator to push the drive member-side protruding portion increases in inverse proportion to the distance from the base portion of the leaf spring as a fulcrum to each protruding portion, according to the principle of leverage. This, however, does not pose a significant problem since the load needed to deform the polyimide film is originally small.

With the configuration described above, it is possible to set the amount of displacement of the piezoelectric actuator at a small value. Therefore, it is possible to use a piezoelectric actuator with a small amount of displacement and thus to reduce the size of the optical switch and optical waveguide device. In addition, it is possible to increase the speed of on/off operation of the optical switch.

(Third Embodiment)

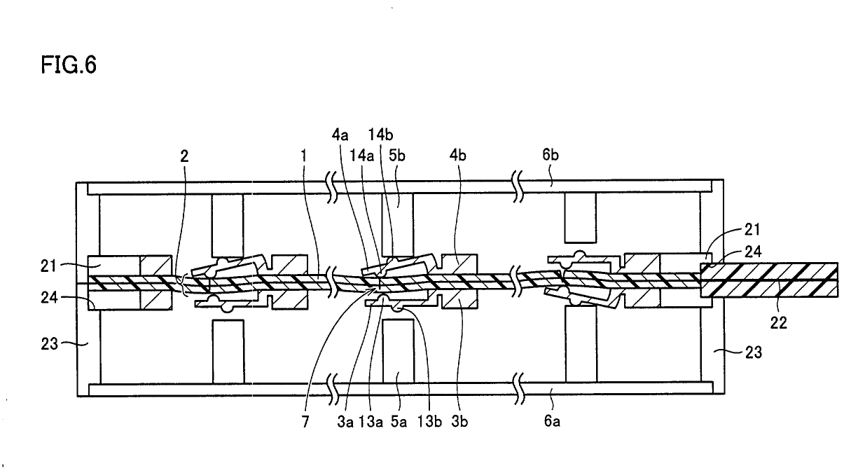

FIG. 6 is a cross sectional view of the optical waveguide device of a third embodiment of the present invention. In the waveguide accommodating sheet of the optical waveguide device, a silicon substrate used in the manufacturing process is etched and a substrate frame 21 is left along the peripheral portion of the waveguide accommodating sheet. A fiber coupling groove 24 is formed within substrate frame 1 to accommodate an end portion of an optical fiber which is coupled to the waveguide within the polyimide film. The end portion of the optical fiber is inserted into fiber coupling groove 24. As a result, coupling of optical fiber 22 with waveguide 2 is realized.

Substrate 21 can be used as a reference frame for affixing the metal plate including the leaf spring to the polyimide film. More specifically, the metal plate is brought to be surrounded by substrate frame 21, and the metal plate can be arranged on the polyimide film accurately using marker 19 as a reference.

A mirror frame 23 is arranged as a member which supports fiber coupling groove 24 and piezoelectric actuators 5a and 5b. In this mirror frame 23, optical fiber 22 is pulled from the outside and accommodated in fiber coupling groove 24. Furthermore, a lower substrate 6a and an upper substrate 6b that fix piezoelectric actuators 5a and 5b, respectively, are supported at its edge part by mirror plate 23.

In accordance with the present embodiment, substrate frame 21 formed of the patterned silicon substrate is used as a frame for fixing the polyimide film and upper and lower substrates 6a and 6b, so that the metal plate, the optical fiber and the piezoelectric actuator can be fixed more easily.

Since mirror frame 23 serves to determine the distance (height) between polyimide film 1 and piezoelectric actuator 5a, 5b, it is desired that mirror frame 23 has a thermal expansion coefficient equivalent to that of the piezoelectric actuator. By adjusting thermal expansion coefficient in this way, even if the length of the piezoelectric actuator changes due to environment temperature variations, mirror frame 23 can also have its size changed similarly. Therefore, the space between polyimide film 1 and the end point of piezoelectric actuator 5a, 5b is not changed, so that the polyimide film can be pressurized with a prescribed constant amount of displacement of the piezoelectric actuator.

(Fourth Embodiment)

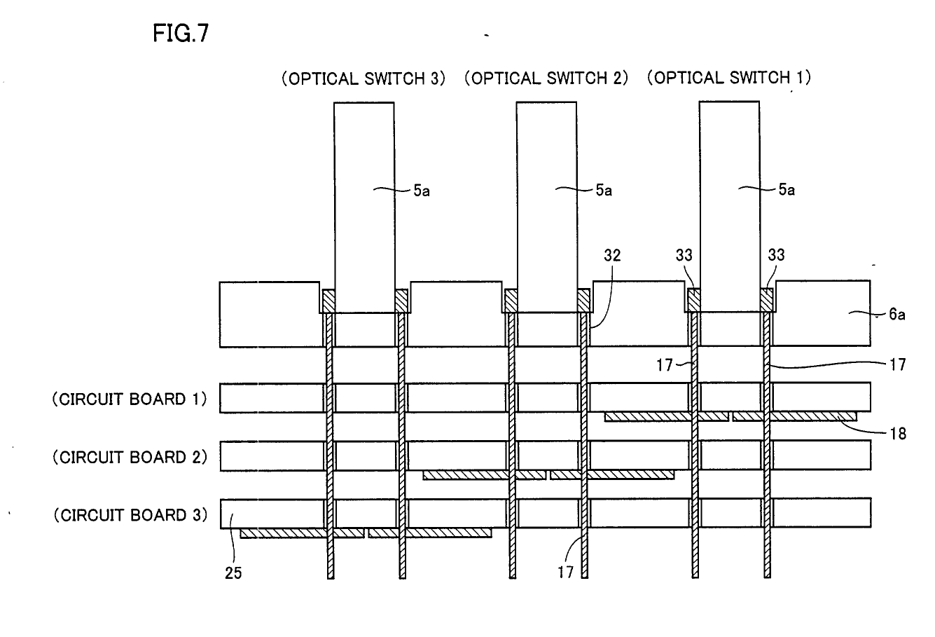

FIG. 7 is a diagram showing the optical waveguide device in a fourth embodiment of the present invention. In this embodiment, description will be made to the arrangement of a circuit board including a drive circuit driving the piezoelectric actuator and a method of connecting the piezoelectric actuator therewith. As shown in FIG. 7, lower substrate 6a supporting the piezoelectric actuator is provided with a insertion slot for securely supporting piezoelectric actuator 5a, and the base portion of the piezoelectric actuator is inserted into the insertion slot. Furthermore, for electrical connection with a circuit board 25 arranged below, a wiring pin 17 is also inserted into the insertion slot from the lower side through a pin hole 32. Wiring pin 17 is electrically and mechanically connected with a connection terminal (not shown) of the piezoelectric actuator by solder 33.

The drive circuit for the piezoelectric actuator is formed by stacking a plurality of circuit boards 25. Since the piezoelectric actuator is normally driven at a high voltage such as 150V, it is difficult to arrange the wiring pattern in high density. Then, two drive circuits arranged to drive the adjacent piezoelectric actuators are allocated to the different circuit boards 25. Wiring pin 17 passes through pin hole 32 past the stacked circuit boards 25 and electrically connects to an electrode pattern 18 of the circuit board having the corresponding drive circuit.

The optical waveguide device in accordance with the present embodiment allows for the size reduction of the circuit board and thus the optical waveguide device without causing a short circuit.

In the foregoing, although the embodiments of the present invention has been described, the embodiments of the present invention as disclosed above are only illustrative and the scope of the present invention is not limited these embodiments of the invention. For example, the contact member may not be limited to the integrally formed metal plate. Alternatively it may be formed with elastic resin. Furthermore, the drive member may not be limited to the piezoelectric actuator. The scope of the present invention is defined by description in the claims and covers all equivalents and changes to the claims.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical switch provided in an optical waveguide device including a waveguide allowing propagation of light and a waveguide accommodating sheet accommodating the waveguide, comprising:
a cut portion formed by cutting in said waveguide accommodating sheet from one surface thereof across said waveguide;
a contact member having a fixed portion and a pressurizing portion at least on that side of said waveguide accommodating sheet which is opposite to a side of said cutting in, said fixed portion being fixed in the vicinity of said cut portion, said pressurizing portion being positioned to be continuous with the fixed portion and two-dimensionally overlap said cut portion; and
a drive member positioned such that said pressurizing portion is sandwiched between said drive member and said waveguide accommodating sheet, whereby the drive member advances toward said pressurizing portion to press said pressurizing portion against said waveguide accommodating sheet and retracts away from said pressurizing portion to disengage said pressurizing portion from said waveguide accommodating sheet.

2. The optical switch according to claim 1, wherein
said contact member and said drive member are provided on both face sides of said waveguide accommodating sheet, and
one of two said drive members located on both face sides of said waveguide accommodating sheet presses one pressurizing portion against said waveguide accommodating sheet to open up said cut portion whereas the other drive member presses the other pressurizing portion against said cut portion to connect said cut portion.

3. The optical switch according to claim 1, wherein
said pressurizing potion includes a sheet contact portion to come into contact with said waveguide accommodating sheet at said cut portion and a drive member contact portion to come into contact with said drive member, and said sheet contact portion and said drive member contact portion are two-dimensionally separated.

4. The optical switch according to claim 1, wherein
said pressurizing portion includes a sheet-side protruding portion to come into contact with said waveguide accommodating sheet at said cut portion and a drive member-side protruding portion to come into contact with said drive member.

5. The optical switch according to claim 1, wherein
said waveguide accommodating sheet and said contact member have approximately the same thermal expansion coefficient.

6. An optical waveguide device comprising waveguides allowing propagation of light, a waveguide accommodating sheet accommodating said waveguides, and a plurality of optical switches each positioned at an intersection of said waveguides, each of said optical switches including
a cut portion formed by cutting in said waveguide sheet from one surface thereof across said waveguide,
a contact member having a fixed portion and a pressurizing portion at least on that side of said waveguide accommodating sheet which is opposite to a side of said cutting in, said fixed portion being fixed in the vicinity of said cut portion, said pressurizing portion being positioned to be continuous with said fixed portion and two-dimensionally overlap said cut portion, and
a drive member positioned such that said pressurizing portion is sandwiched between said drive member and said waveguide accommodating sheet, whereby the drive member advances toward said pressurizing portion to press said pressurizing portion against said waveguide accommodating sheet and retracts away from said pressurizing portion to disengage said pressurizing portion from said waveguide accommodating sheet, wherein
the contact members positioned corresponding to each of a plurality of said cut portions in said optical waveguide device are formed from one metal plate that is integrally formed.

7. The optical waveguide device according to claim 6, wherein
said waveguide accommodating sheet is provided with a frame portion along a peripheral portion of the waveguide accommodating sheet, and said integrally formed metal plate is arranged to be surrounded with said frame portion.

8. The optical waveguide device according to claim 6, further comprising a casing supporting said waveguide accommodating sheet and said drive member, wherein
said casing has approximately the same thermal expansion coefficient as said drive member.

9. An optical waveguide device comprising waveguides allowing propagation of light, a waveguide accommodating sheet accommodating said waveguides, and a plurality of optical switches each positioned at an intersection of said waveguides, each of said optical switches including
a cut portion formed by cutting in said waveguide sheet from one surface thereof across said waveguide,
a contact member having a fixed portion and a pressurizing portion at least on that side of said waveguide accommodating sheet which is opposite to a side of said cutting in, said fixed portion being fixed in the vicinity of said cut portion, said pressurizing portion being positioned to be continuous with said fixed portion and two-dimensionally overlap said cut portion,
a drive member positioned such that said pressurizing portion is sandwiched between said drive member and said waveguide accommodating sheet, whereby the drive member advances toward said pressurizing portion to press said pressurizing portion against said waveguide accommodating sheet and retracts away from said pressurizing portion to disengage said pressurizing portion from said waveguide accommodating sheet, and
an electrical drive unit electrically driving said drive member, wherein
said electrical drive unit is formed by stacking a plurality of circuit boards, and adjacent drive members among said drive members are connected to different circuit boards.

10. The optical waveguide device according to claim 9, further comprising a casing supporting said waveguide accommodating sheet and said drive member, wherein
said casing has approximately the same thermal expansion coefficient as said drive member.
